(19) United States
(12) Patent Application Publication
(10) Pub. No.: US 2012/0102564 A1
(43) Pub. Date: Apr. 26, 2012

(54) CREATING DISTINCT USER SPACES THROUGH MOUNTABLE FILE SYSTEMS

(75) Inventors: Philip Schentrup, Hollywood, FL (US); Michael Kelly, Deerfield Beach, FL (US)

(73) Assignee: OPENPEAK INC., Boca Raton, FL (US)

(21) Appl. No.: 13/252,940

(22) Filed: Oct. 4, 2011

Related U.S. Application Data
(60) Provisional application No. 61/406,308, filed on Oct. 25, 2010.

(51) Int. Cl. G06F 21/24; H04W 12/06

(52) U.S. Cl. 726/16; 726/26; 726/28

(57) ABSTRACT

A method and a processing system for creating distinct user spaces. In a platform originally intended to be a single user platform, for each of a plurality of users, at least one mountable element can be uniquely assigned to the user and data associated with the user can be stored to the assigned mountable element to create a multi-user platform.

### CROSS REFERENCES TO RELATED APPLICATIONS

This application claims benefit of U.S. provisional patent application Ser. No. 61/406,308, filed Oct. 25, 2010, which is herein incorporated by reference. In the case of conflict, the present specification, including definitions, will control.

### BACKGROUND OF THE INVENTION

1. Field of Technology

The present description generally relates to operating systems and, more particularly, to multi-user accounts in operating systems with access restrictions.

2. Background

Android™ is a software stack for mobile devices based on the Linux™ platform, and currently is developed by Google, Inc. of Mountain View, Calif. Although Linux™ supports multiple users, Android™ is designed to be a single user platform. In this regard, the Android™ system effectively disables the multi-user aspect of the Linux™ kernel by assigning unique user identifications (user IDs) to each Android™ application. In particular, when an Android™ application reads or writes data, the application only can access the data with its unique user ID. Thus, such an application can only read or modify data that the application itself creates. This feature is necessary to prevent potentially unscrupulous applications from accessing sensitive information generated by other applications.

### SUMMARY

Arrangements described herein relate to a method of creating distinct user spaces. The method can include, in a platform originally intended to be a single user platform, for each of a plurality of users, uniquely assigning to the user at least one mountable element and causing data associated with the user to be stored to the assigned mountable element to create a multi-user platform. The method further can include, when a current user logs on to the platform, mounting the at least one mountable element assigned to the current user to enable the current user to access the data associated with the current user. The current user can be authenticated prior to mounting the at least one mountable element assigned to the current user.

When the current user logs off of the platform, at least one mountable element assigned to the current user can be un-mounted to prevent other users from accessing the user data associated with the current user. Further, when the current user logs off of the platform, the at least one mountable element assigned to the current user can be secured to prevent other users from accessing the user data associated with the current user. Uniquely assigning to the user at least one mountable element can include assigning to the user a plurality of mountable elements.

The method further can include selectively encrypting and decrypting the user data. Decrypting the user data can include decrypting the user data for the current user and moving the decrypted data from the at least one mountable element to a volatile data storage element.

Another arrangement described herein relates to a processing system. The processing system can include a processor configured to, in a platform originally intended to be a single user platform, for each of a plurality of users, uniquely assign to the user at least one mountable element and cause user data associated with the user to be stored the assigned at least one mountable element to create a multi-user platform. When a current user logs on to the platform, the at least one mountable element assigned to the current user can be mounted to enable the current user to access the user data associated with the current user. The processor further can be configured to authenticate the current user prior to mounting the at least one mountable element assigned to the current user.

When the current user logs off of the platform, the at least one mountable element assigned to the current user can be un-mounted to prevent other users from accessing the user data associated with the current user. Further, when the current user logs off of the platform, the at least one mountable element assigned to the current user can be secured to prevent other users from accessing the user data associated with the current user. The processor further can be configured to assign to the user a plurality of mountable elements and to selectively encrypt and decrypt the user data. For example, the processor can be configured to decrypt the user data for the current user and move the decrypted data from the at least one mountable element to a volatile data storage element.

Another arrangement described herein relates to a mobile device. The mobile device can include a display and a processor. The processor can be configured to, in a platform originally intended to be a single user platform, for each of a plurality of users, uniquely assign to the user at least one mountable element and cause user data associated with the user to be stored to the assigned at least one mountable element to create a multi-user platform. The mobile device further can include an encryption engine that selectively encrypts or decrypts data. The mobile device also can include an authentication module that authenticates at least one of the plurality of users of the mobile device. At least one mountable element can include at least one local mountable element. Further, at least one mountable element can include at least one mountable element communicatively linked to the mobile device via a communication port or a communication network.

Another arrangement can include a computer program product including a computer-readable storage device. The computer-readable storage device can include computer-usable program code stored thereon, executable by a processor, to perform the various steps and/or functions disclosed within this specification.

### BRIEF DESCRIPTION OF THE DRAWINGS

Embodiments will be described below in more detail, with reference to the accompanying drawings, in which:

FIG. 1 is a block diagram illustrating a system in accordance with one embodiment; and

FIG. 2 is a flowchart illustrating a method for creating multiple independent user spaces in accordance with one embodiment.

### DETAILED DESCRIPTION

While the specification concludes with claims defining features that are regarded as novel, it is believed that the claims will be better understood from a consideration of the description in conjunction with the drawings. As required, detailed embodiments are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ virtually any appropriately detailed structure. Further, the terms and phrases used herein are not intended to be limiting but rather to provide an understandable description.

Several definitions that apply throughout this document will now be presented. The term “current user” is defined as a user of the plurality of users who currently has access to the programs and/or features of a processing device. A “user space” is defined as an environment reserved for a particular user where that user may access various types of data and perform other computing or communication operations. A “platform” is defined as an operating environment composed of hardware and/or software components that serve as interfaces or specifications for interactions within a processing device. A “single user platform” is defined as a platform that is designed, or intended, to accommodate a single user space and possibly an administrator with default control over the platform. A “multi-user platform” is defined as a platform that is designed to accommodate more than one user space and possibly an administrator with default control over the platform. The phrase “originally intended to be a single user platform” is defined as a platform that is or was designed to be a single user platform but that has or will be altered or modified in some way to accommodate more than one user space.

The term “processing device” is defined as an electronic device configured to conduct various operations that manipulate or process data. The term “processing system” is defined as a system comprising a processing device. As such, a processing system can include one or more peripheral devices communicatively linked to the processing device, but this need not be the case. Examples of peripheral devices can include, but are not limited to, external machine-readable storage devices, user input devices (e.g., a mouse, keyboard, etc.), external displays, and the like.

A “processor” is defined as a component or a group of components that execute(s) sets of instructions. A “computer-readable-storage medium” is defined as a non-transitory storage device that can contain, or store, a program for use by or in connection with an instruction execution system, apparatus or device. Examples of a computer-readable-storage medium include, but are not limited to, a hard disk drive (HDD), a solid state drive (SSD), a read-only memory (ROM), an erasable programmable read-only memory (EPROM or Flash memory), a portable compact disc read-only memory (CD-ROM), a digital versatile disk (DVD) and a floppy disk. A “program product” is defined as a device comprising a computer-readable-storage medium having stored thereon computer-usable program code.

A “network” is defined as a collection of two or more components in which the components are permitted to at least exchange signals with one another. The word “data” is defined as all forms of information that are capable of being generated and at least temporarily stored. The word “plurality” means a number that is greater than one. An “interface” is defined as a component or a group of components that connect(s) two or more separate systems or elements such that signals can be exchanged between or among them. A “directory” is defined as a digital file system structure that includes files and folders and that organizes the files and folders into a hierarchical organization. The word “link” is defined as an object that specifies the location of another object. A “symbolic link” is defined as a file system construct that contains a reference to another file or directory in the form of an absolute or relative path and that affects pathname resolution.

A “data storage element” is defined as a component or a group of interconnected components that are configured to retain data subject to retrieval. The term “non-volatile data storage element” means a data storage element, such as a computer-readable storage device, that is configured to retain data irrespective of whether the data storage element is receiving power. The term “volatile data storage element” means a data storage element that requires power during at least some interval to retain data. An example of volatile data storage is random access memory (RAM). The term “mountable element” is defined as an element that stores data for later retrieval and is compatible with the process of mounting (and un-mounting) to permit a host operating system to retrieve such data. Examples of a mountable elements include all or a portion of a HDD, SSD, ROM, EPROM, Flash memory, CD-ROM, DVD, and the like. Another example of a “mountable element” is a pseudo-device, which can be normal files within the file system that are treated as a mountable element.

As used herein, to cause data to be stored means to effectuate storage of the data. For example, to cause data to be stored can include storing the data to a data storage element, or to communicate the data to another system or device which stores the data to a storage element. The phrase “collectively store data” is defined as a process to effectuate storage of multiple portions of data across multiple storage elements or across a single storage element. For example, one or more portions of the data can be stored to a plurality of local data storage elements, communicated to one or more other systems or devices which store the data to a plurality of data storage elements, stored to one or more local data storage elements and communicated to one or more other systems or devices which store the data to one or more data storage elements, or the like.

The term “fixed allocation” is defined as an allocation of memory/storage that is assigned prior to the execution of any programs or operations that may utilize the allocation and stays static during such execution of the programs or operations. In contrast, a “dynamic allocation” is defined as an allocation of memory/storage that may or may not be assigned prior to the execution of any programs or operations that may utilize the allocation and is adjustable prior to, during or following such execution of the programs or operations. The terms “encrypt” or “encrypting” are defined as altering or translating data to restrict access to the data, while the terms “decrypt” or “decrypting” are defined as decoding data that has been encrypted. The phrase “securing at least one mountable element” means allow a designated user to access (e.g., store data to or access data from) the mountable element, while preventing other users from accessing the mountable element.

As noted, the Android™ system repurposes the multi-user aspect of the Linux kernel by assigning unique user IDs to each Android™ application. The distinctive user IDs are necessary to protect sensitive data that is related to various applications stored on a device. In particular, arrangements described herein relate to, in a platform originally intended as a single user platform, creating distinct user spaces in a processing device in order to segment user data associated with a plurality of users. The user spaces are created by mapping specific data storage paths for each user. When a user logs on to the processing device, the user's data storage paths can be mounted. When the user logs off of the processing device, the user's data storage paths can be un-mounted and the data in the user's data storage paths can be secured against access by other users. These arrangements do not affect the practice of assigning unique user IDs for applications as normally performed by Android™. This is in contrast to the manner in which Android™ typically operates. Specifically, Android™ typically stores all application data into a data storage path, for example the “/data/data” storage path.

Because mountable elements can be mounted and un-mounted without affecting application user IDs, the present arrangements can bring additional functionality to a processing device without compromising its security. Thus, consumers who have grown accustomed to multi-user experiences on processing devices can continue to realize such an experience on units powered by certain restrictive operating system environments.

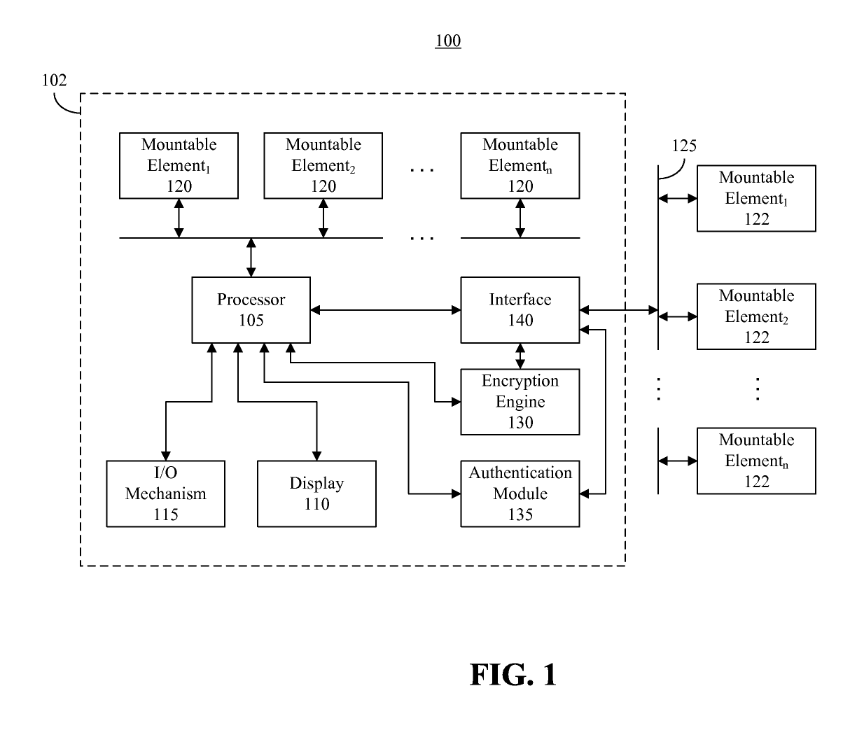

FIG. 1 is a block diagram illustrating a processing system (hereinafter “system”) 100 in accordance with one embodiment. The system 100 can include a processing device 102. The processing device 102 can be a computer (e.g., a desktop computer), a mobile device (e.g., a laptop computer, a notebook computer, a tablet computer, a personal digital assistant (PDA), a mobile telephone (e.g., a smart phone), or the like), an entertainment device, or any other device suitable for processing data.

The processing device 102 can include a processor 105, which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

In one arrangement, the processing device 102 also can include one or more input/output (I/O) devices, for example a display 110. In one arrangement, the display 110 can be a touch screen display, though the invention is not limited in this regard. Another example of an I/O device can include an I/O mechanism 115, such as a keyboard, a mouse, or the like. Of course, the display 110, if built as a touch screen display, may serve as the I/O mechanism 115. It must be noted, however, that the processing device 102 is not necessarily limited to these types of user interface elements, as other forms of such components may be implemented into the processing device 102.

The I/O devices can be coupled to the processor 105 either directly or through intervening I/O controllers. One or more interfaces 140 also can be coupled to the processor 105 to enable the processing device 102 to become coupled to other systems, computer systems, remote printers, and/or remote storage devices through intervening private or public networks. Modems, cable modems, Ethernet cards and communication ports are examples of different types of interfaces 140 that can be used with the processing device 102. Examples of communication ports include, but are not limited to, serial ports, parallel ports, universal serial bus (USB) ports, IEEE-1394 (FireWire) ports, serial ATA (SATA) ports, external SATA (eSATA) ports, and the like.

The processing device 102 also can include one or more mountable elements 120, 122, which can be used to store various forms of data. The mountable elements 120, 122 can be volatile mountable elements or non-volatile mountable elements. The mountable elements 120 can be integrated within (permanently or temporarily) the processing device 102. As such, the mountable elements 120 can be referred to as local mountable elements. The mountable elements 120 can be coupled to the processor 105 either directly or through intervening I/O controllers.

The mountable elements 122 can be communicatively linked to the processing device 102 via the communication network 125, via a communication port, or in any other suitable manner. As such, the mountable elements 122 can be referred to as remote mountable elements. The communication network 125 can comprise a wide area network (WAN), such as the Internet, a local area network (LAN), a personal area network (PAN) (e.g., Bluetooth®), and/or any other suitable communication systems. In this regard, the communication network 125 can include wired and/or wireless communication links.

In one arrangement, the processing device 102 can also include an encryption engine 130, which can be used to selectively encrypt and/or decrypt data. Any suitable type and number of encryption and decryption techniques can be employed to ensure secure and efficient retrieval of data. As another option, the processing device 102 can include an authentication module 135 for authenticating one or more users of the processing device 102. The authentication module 135 can perform authentications on its own or in conjunction with one or more other elements, as will be described herein.

If desired, the encryption engine 130 and the authentication module 135 can be directly and communicatively coupled to the interface 140 for exchanging signals with the external devices communicatively linked with the communication device 102 via the communication network 125 or via other communication links, such as those communication ports previously described. In one arrangement, the encryption engine 130 and the authentication module 135 can be embodied as application specific devices coupled to the processor 105 either directly or through intervening I/O controllers. In another arrangement, the encryption engine 130 and the authentication module 135 can be embodied as applications executable by the processor 105. In this regard, the encryption engine 130 and the authentication module 135 can be stored on one or more data storage elements communicatively linked to the processor 105.

In accordance with the description herein, the processing device 102 can be configured to accommodate multiple users. This feature is possible even if the processing device 102 is equipped with a platform that was originally intended for use by a single individual. In particular, each user can operate the processing device 102 and can generate, store and retrieve data on the processing device 102. This data can be stored on any number or type of the mountable elements 120, 122 including those that are communicatively linked to the processing device 102 via the communication network 125. In this regard, the processor 105 can cause the data to be stored to the mountable elements 120, 122. In addition, a particular user's data can be secured (e.g., protected) from unauthorized access by any of the other users of the processing device 102. These processes can be achieved with minimal affect on the original single user platform of the processing device 102.

User data can be stored on any suitable number/combination of mountable elements 120, 122. To accommodate requests for access to a user's data in the mountable elements 120, 122, the processing device 102 may employ any suitable type of a mountable file system or protocol. Suitable examples of a mountable file system or protocol include a network mountable file system like Network File System (NFS), a loop device-based file system like vnode disk (vnd) or Filesystem in Userspace (FUSE) and a disk partition. Of course, these are merely examples, as the system can take advantage of virtually any mountable file system object to enable a host operating to access data across any type or number of mountable elements 120, 122.

Consider the scenario where the processing device 102 supports multiple users, each of whom has data stored over various mountable elements 120, 122. A first user may log in to the processing device 102, in which case the first user can be referred to as a “current user.” Once the first user is logged in, any file systems that are currently mounted, for example file systems used by a previous user, can be un-mounted, and the current user's file systems can be mounted. For example, consider application data, cache data and media data directories. Data relating to these directories may be stored across various mountable elements 120, 122, both local and remote. When the first user logs in, the current file systems mounted at /application, /cache and /media, which are associated with a previous user, can be un-mounted. The first user's file systems can then be mounted to the /application, /cache and /media directories. Similarly, when a subsequent (and different) user logs in, this process of un-mounting/mounting can be repeated to permit the new user to access his/her data.

In the case of loop device-based file systems, each loop device may be stored as a regular file within the host (e.g., Linux™) file system. The loop device file can be locally or remotely located. When the loop device file is mounted, Linux™ may treat the file as a block device capable of holding file system elements, such as other files and directories. In this way, the loop device can encapsulate user data. Each user may have three or more loop devices based on the exemplary configuration described above. For example, each user can have one loop device to mount to /application, one loop device to mount to /cache and one loop device to mount to /media. Other loop devices also may be provided for each user, and the invention is not limited in this regard.

In one arrangement, a software layer can be created in user space to perform mapping of file paths based on user identifiers. The software layer can be implemented using FUSE, but the invention is not limited in this regard. The user identifiers need not be Linux™ based user identifiers, but instead can provide indications of actual users. In illustration, a request from a User 1 (a currently selected user) for /data/UserData/song1 may be translated by the software layer to a request for /data/User1/UserData/song1. As can be seen, the software layer can map the request to a current user's file space. Numeric user IDs also can be employed for the translation. Moreover, the process described here can be used by other modules that allow users to create file systems without editing kernel code.

Encryption of user data can also be supported through mountable encryption file systems, like TrueCrypt or other on the fly encryption software, or by secured file system connections to encrypted backend servers. Data protection can be accomplished on systems that support user permission levels by restricting the ability to mount devices to super users or system administrators. Access to the files used to encapsulate data can be restricted by setting the permissions for files of users who are not logged in to super user only access. In Linux, for example, non-active users can have the permissions of their loop device files or mountable elements set to “root” only to prevent access of their data.

For file systems that do not support dynamic mounting of mountable elements, the process of logging in may rename/move a user's directory to a required path. For instance, /dataTop/user1 can be moved to /data when user1 logs in. In general, any process of rearranging the file system to support making a user's data accessible via an expected path setting can be used.

The user log in process may be accomplished in any number of ways. For example, a key lock screen, such as one provided by Android™, can be modified so that a log in is required prior to be able to access a device. In one arrangement, the user log in can be conducted via a thin web client, where a user can log into a back-end server, and the user is authenticated by the server. The server can then send the device a message that a new user has logged in. Virtually any feature that restricts access pending some authentication can be employed.

When switching active data spaces as specified above, the issue of currently running processes that may be using the current active data space can be considered. Before switching data spaces, all user specific processes may be terminated, and system processes that access a particular user's data space may need to be terminated and re-started when the new user's data space is installed. For example, a social media application may be a user specific application. When switching users, the social media application can be terminated in such a way to avoid an abrupt shutdown. In illustration, Android™ activities and services have application programming interfaces (API) to support the persistence of data. If the device employs Android™, the shutdown can be executed by calling the appropriate termination command or sequence of the social media application, such as an on Pause or on Destroy( )method. This can indicate to the application that the application should be terminated and any persistent data should be saved, for example using a suitable API. An example of a system service that may need re-starting upon the switching of an active data space is an automatic background e-mail service. The e-mail resources (e.g., e-mail folders, log in info, etc.) may be specific to a particular user and may be contained in the user's data space, but the service may run for all users.

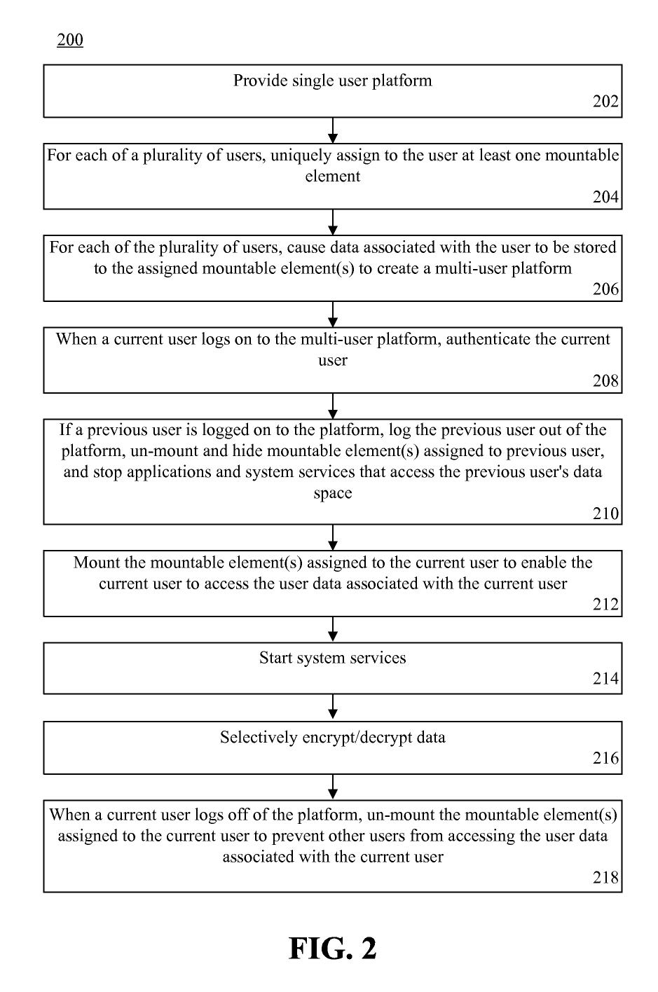

FIG. 2 is a flowchart illustrating a method 200 for creating multiple independent user spaces in accordance with one embodiment. When describing the method 200, reference will be made to the elements of FIG. 1, although it is understood that the method 200 can be practiced in any other suitable system or with any other suitable components. Further, the method 200 is not necessarily limited to the chronological order presented in FIG. 2, as these steps can be executed in accordance with any suitable sequence. Also, the method 200 may be adjusted to include other processes or operations not recited here or to remove some of the steps illustrated in FIG. 2.

At step 202, a single user platform can be provided on a processing device. At step 204, for each of a plurality of users, at least one mountable element can be uniquely assigned to the user. In an arrangement in which a plurality of mountable elements are uniquely assigned to the user, each of the mountable elements can be defined on the same data storage element. Alternatively, two or more of the mountable elements can be defined on different data storage elements.

The unique assignment of at least one mountable element to each user creates a distinct and independent user space for each user. A “distinct and independent user space” is defined as a user space that exists with no dependency on another user space and is protected from access by other users, except for possibly an administrator with default control over the created user spaces. At step 206, for each of the plurality of users, user data associated with the user can be caused to be stored to the mountable element(s) assigned to the user.

The process described in steps 202-206 can convert the single user platform to create a multi-user platform such that each user is assigned one of the independent user spaces. To help explain these steps, reference will be made to FIG. 1. Initially, in one arrangement, the processing device 102 may include a single user platform. The processing device 102, however, may be altered to create multiple user spaces to allow a plurality of users to use the processing device 102 without fear of unauthorized access to their data. To accomplish this feature, the single user platform on the processing device 102 is effectively converted to a multi-user platform.

Each of the plurality of users may have data associated with them stored on one or more mountable elements 120 of the processing device 102 and/or one or more mountable elements 122 communicatively linked to the processing device 102 via the communication network 125. The processor 105 of the processing device 102 can manage the storage of this data. Consider the example where there are two authorized users for the processing device 102. Both users may generate data associated with their activities on the processing device 102, and this data may be stored on one or more mountable elements 120, 122. Specifically, the data associated with each user can be stored to mountable elements 120, 122 assigned to that user.

The type of data the plurality of users may generate can take on many forms. Several exemplary types of data include application data, cache data, media data and system data. The term “application data” is defined as data that is associated with programs designed for direct interaction with an end user. The term “cache data” is defined as data that is or will be temporarily stored in a storage mechanism. The term “media data” is defined as data that is associated with the presentation of media content to a user. Media content can include, but is not limited to, audio information, video information, audio/video information, text, graphics and the like. The term “system data” is defined as data that is used by the platform to configure and/or control the system. System data can be unique to each user, though this need not be the case.

The examples presented herein are not intended to be limiting. In one particular arrangement, application data and system data associated with the plurality of users can be stored in one mountable element 120, 122, while the cache data associated with the users can be stored at a different location of the mountable element 120, 122 or on a different mountable element 120, 122. Similarly, the media data associated with the plurality of users can be stored at a different location of the mountable element 120, 122. Further, certain application data, cache data, system data or the media data can be stored on a mountable element 120, 122 separate from the other mountable element(s) 120, 122 storing different application data, cache data, system data or the media data.

Referring now to step 208 of FIG. 2, when a current user logs on to the multi-user platform of the processing device, the current user can be authenticated, for example using system permissions. Many procedures may be used to authenticate the current user. As an example, the current user can enter a password, which the processor 105 can verify to authenticate the current user. As another example, the processing device 102 can be equipped with software and circuitry to enable the current user to provide a biometric sample or measurement, such as a fingerprint, iris scan or voice sample. The processor 105 can also authenticate the current user based on these samples. In yet another example, the criteria used to verify the identity of the current user can be processed at a remote location, such as by a suitable mechanism in the communication network 125. Once authenticated by the remote location, the remote location can signal the processor 105, which can then take steps to provide the appropriate level of access for the authenticated user. Although not necessary, each of the plurality of users may be required to be authenticated before being granted access to user data.

At step 210, if a previous user is currently logged on to the platform when the current user logs on to the platform, the previous user can be logged out of the platform. Further, mountable elements assigned to the previous user can be un-mounted and hidden so that the mountable elements are not depicted in a system view of the platform. In addition, applications and system services that access the previous user's data space can be stopped.

At step 212, the mountable element(s) assigned to the current user can be mounted to enable the current user to access the user data associated with the current user. At step 214, system services can be started. At step 216, the current user's data can be selectively encrypted and/or decrypted. For example, the user data for the current user can be decrypted and moved from the mountable element(s) to a volatile data storage element. Data to be stored to the mountable element(s) can be encrypted and moved from the volatile data storage to the mountable element(s).

At step 218, when a current user logs off of the platform, the mountable element(s) assigned to the current user can be secured to prevent other users from accessing the user data associated with the current user. Further, the mountable element(s) assigned to the current user can be un-mounted. If, however, the current user does not log off of the platform, the current users mountable element(s) can remain mounted until another user logs on to the platform. In one arrangement, a current user can be automatically logged off after expiration of a certain period of time wherein no activity by the current user is detected on the platform. When the user is automatically logged off, the mountable element(s) assigned to the user can be secured and un-mounted.

Although there are references to Linux™ and Android™, it should be noted that the description contained herein is applicable to any operating system, kernel or software platform where support for multiple-user accounts is not provided or available.

The flowchart and block diagram in the figures illustrate the architecture, functionality, and operation of possible implementations of systems, methods and computer program products according to various embodiments. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable or computer-readable program code that, when being loaded and executed, controls the processing system such that it carries out the methods described herein. The systems, components and/or processes also can be embedded in a non-transitory computer-readable storage device, such as a computer-readable storage device of a computer program product or other data programs storage device, readable by a machine, tangibly embodying a program of instructions executable by the machine to perform methods and processes described herein. These elements also can be embedded in a computer program product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

The present arrangements can be embodied in other forms without departing from the spirit or essential attributes thereof. Accordingly, reference should be made to the following claims, rather than to the foregoing specification, as indicating the scope of the invention.

What is claimed is:

1. A method of creating distinct user spaces, comprising:
in a platform originally intended to be a single user platform, for each of a plurality of users:
uniquely assigning to the user at least one mountable element; and
causing data associated with the user to be stored to the assigned mountable element to create a multi-user platform.

2. The method according to claim 1, further comprising:
when a current user logs on to the multi-user platform, mounting the at least one mountable element assigned to the current user to enable the current user to access the data associated with the current user.

3. The method according to claim 2, further comprising authenticating the current user prior to mounting the at least one mountable element assigned to the current user.

4. The method according to claim 2, further comprising:
when the current user logs off of the multi-user platform, un-mounting the at least one mountable element assigned to the current user to prevent other users from accessing the user data associated with the current user.

5. The method according to claim 4, further comprising:
when the current user logs off of the multi-user platform, securing the at least one mountable element assigned to the current user to prevent other users from accessing the user data associated with the current user.

6. The method according to claim 1, wherein:
uniquely assigning to the user at least one mountable element comprises assigning to the user a plurality of mountable elements.

7. The method according to claim 1, further comprising selectively encrypting and decrypting the user data.

8. The method according to claim 7, wherein decrypting the user data comprises decrypting the user data for the current user and moving the decrypted data from the at least one mountable element to a volatile data storage element.

9. A method of creating distinct user spaces, comprising:
in a platform originally intended to be a single user platform, for each of a plurality of users:
uniquely assigning to the user at least one mountable element;
causing data associated with the user to be stored to the assigned mountable element to create a multi-user platform;
when the user logs on to the multi-user platform, mounting the at least one mountable element assigned to the user to enable the user to access the data associated with the user; and
when the user logs off of the multi-user platform, securing the at least one mountable element assigned to the user to prevent other users from accessing the user data associated with the user.

10. A processing system, comprising:
a processor configured to, in a platform originally intended to be a single user platform, for each of a plurality of users:
uniquely assign to the user at least one mountable element; and
cause user data associated with the user to be stored to the assigned at least one mountable element to create a multi-user platform.

11. The processing system of claim 10, wherein the processor further is configured to:
when a current user logs on to the multi-user platform, mount the at least one mountable element assigned to the current user to enable the current user to access the user data associated with the current user.

12. The processing system of claim 11, wherein the processor further is configured to authenticate the current user prior to mounting the at least one mountable element assigned to the current user.

13. The processing system of claim 11, wherein the processor further is configured to, when the current user logs off of the multi-user platform, un-mount the at least one mountable element assigned to the current user to prevent other users from accessing the user data associated with the current user.

14. The processing system of claim 13, wherein the processor further is configured to, when the current user logs off of the multi-user platform, secure the at least one mountable element assigned to the current user to prevent other users from accessing the user data associated with the current user.

15. The processing system of claim 10, wherein the processor further is configured to assign to the user a plurality of mountable elements.

16. The processing system of claim 10, wherein the processor further is configured to selectively encrypt and decrypt the user data.

17. The processing system of claim 16, wherein the processor further is configured to decrypt the user data for the current user and move the decrypted data from the at least one mountable element to a volatile data storage element.

18. A mobile device, comprising:
a display; and
a processor configured to, in a platform originally intended to be a single user platform, for each of a plurality of users:
uniquely assign to the user at least one mountable element; and
cause user data associated with the user to be stored to the assigned at least one mountable element to create a multi-user platform.

19. The mobile device of claim 18, further comprising:
an encryption engine that selectively encrypts or decrypts data.

20. The mobile device of claim 18, further comprising:
an authentication module that authenticates at least one of the plurality of users of the mobile device.

21. The mobile device of claim 18, wherein the at least one mountable element comprises at least one local mountable element.

22. The mobile device of claim 18, wherein the at least one mountable element comprises at least one mountable element communicatively linked to the mobile device via a communication port or a communication network.

23. A computer program product comprising:
a computer-readable storage device comprising computer-usable program code stored thereon that creates distinct user spaces, the computer-readable storage device comprising:
computer-usable program code configured to, in a platform originally intended to be a single user platform, for each of a plurality of users:
uniquely assign to the user at least one mountable element; and
cause user data associated with the user to be stored to the assigned at least one mountable element to create a multi-user platform.

24. The computer program product of claim 23, the computer-readable storage device further comprising:
computer-usable program code configured to, when a current user logs on to the multi-user platform, mount the at least one mountable element assigned to the current user to enable the current user to access the user data associated with the current user.

25. The computer program product of claim 24, the computer-readable storage device further comprising computer-usable program code configured to authenticate the current user prior to mounting the at least one mountable element assigned to the current user.

26. The computer program product of claim 24, the computer-readable storage device further comprising computer-usable program code configured to, when the current user logs off of the multi-user platform, un-mount the at least one mountable element assigned to the current user to prevent other users from accessing the user data associated with the current user.

27. The computer program product of claim 26, the computer-readable storage device further comprising computer-usable program code configured to, when the current user logs off of the multi-user platform, secure the at least one mountable element assigned to the current user to prevent other users from accessing the user data associated with the current user.

28. The computer program product of claim 23, wherein:
the computer-usable program code configured to uniquely assign to the user at least one mountable element comprises computer-usable program code configured to uniquely assign to the user a plurality of mountable elements.

29. The computer program product of claim 23, the computer-readable storage device further comprising computer-usable program code configured to selectively encrypt and decrypt the user data.

30. The computer program product of claim 29, wherein the computer-usable program code configured to selectively decrypt the user data comprises computer-usable program code configured to decrypt the user data for the current user and move the decrypted data from the at least one mountable element to a volatile data storage element.
